(19) United States
(12) Patent Application Publication
(10) Pub. No.: US 2017/0157658 A1
(43) Pub. Date: Jun. 8, 2017

(54) AUTOMATIC-ALIGNMENT LOAD-DETECTION APPARATUS AND METHOD USED FOR A WIRE DRAWING MACHINE

(71) Applicant: Metal Industries Research & Development Centre, Kaohsiung (TW)

(72) Inventors: Hsu-Fu Wu, Kaohsiung (TW); Cheng-Hsueh CHIANG, Kaohsiung (TW); De-Chang TSAI, Kaohsiung (TW)

(21) Appl. No.: 14/979,857

(22) Filed: Dec. 28, 2015

(30) Foreign Application Priority Data
Dec. 4, 2015 (TW) 104140738

(51) Int. Cl. B21C 51/00; G01N 3/56; B21C 3/12

(52) U.S. Cl. CPC B21C 51/00; B21C 3/12; G01N 3/56

(57) ABSTRACT

An automatic-alignment load-detection apparatus includes: a drawing die, an adapter ring, a tapered spacer and a force sensor. An automatic-alignment load-detection method includes steps of: providing an automatic-alignment load-detection apparatus used for a wire drawing machine, and applying a pulling force, to enable a wire to pass through the drawing die, the adapter ring, the tapered spacer and the force sensor. At the same time when the wire is being pulled, the wire can pass through the drawing die and rub against the drawing die, to enable the drawing die to apply a force on the adapter ring, the tapered spacer, and the force sensor, so as to further enable the force sensor to detect an axial-direction load, so that a wear degree of the drawing die can be detected in real time by using the axial-direction load, and the quality of a wire can be determined in real time.

### CROSS-REFERENCE TO RELATED APPLICATION

This application claims the benefit of Taiwan Patent Application No. 104140738, filed on Dec. 4, 2015, which is hereby incorporated by reference for all purposes as if fully set forth herein.

### TECHNICAL FIELD

The present invention relates to an automatic-alignment load-detection apparatus and method, and in particular, to an automatic-alignment load-detection apparatus and method used for a wire drawing machine.

### BACKGROUND

In an existing technology of processing a metal wire having a relatively large wire diameter into a metal wire having a relatively small wire diameter, a wire drawing machine is generally used to pull and guide a metal wire; particularly, the metal wire passes through a drawing die configured in the wire drawing machine, so as to achieve an effect of reducing a wire diameter of the metal wire.

However, in an existing process of making a wire to shrink by using a drawing die, wear of the drawing die is unpredictable. Therefore, the drawing die is required to be disassembled to determine whether the drawing die has worn, which consumes a great amount of effort, labor, and time. In addition, since a wear degree of the drawing die is unpredictable, the quality of a wire cannot be detected at the same time when wire diameter of the wire is being reduced. The quality of the wire can be detected only after an operation of reducing the wire diameter of the wire is completed.

For example, in the TW patent reference (patent no.: TW I272976), a wire drawing machine, a wire drawing device, and a method for controlling the wire drawing device are disclosed. The wire drawing machine includes: a first driving unit, a second driving unit, and a wire drawing unit. The wire drawing device includes: a wire drawing machine, an annealer, and a computer console. The method for controlling the wire drawing machine device include steps of: (1) providing a wire drawing machine, an annealer, and a computer console; (2) introducing a group of manufacturing parameters in the computer console; and (3) feeding a wire and turning on a manufacturing switch of the computer console, wherein a computer human-machine interface provided by the computer console is used to control the wire drawing machine and the annealer, and control the two driving units to separately drive a step pulley and an idler pulley of the wire drawing machine to pull and drive the wire, so that wear between the step pulley and the wire and wear between the idler pulley and the wire are reduced, and a stability degree of manufacturing quality of the wire can be improved.

Although in the TW patent reference (TW 1272976), related manufacturing parameters of a wire drawing device can be integrated as manufacturing records and stored in a computer console of the wire drawing device, thereby achieving simplification of a manufacturing procedure of a wire and improvement of a stability degree of manufacturing quality of the wire. However, the quality of a wire is determined after a wire diameter of the wire is still required to be reduced to further perform detection, rather than that the quality of the wire is determined at the same time when the wire is passing through a drawing die and the wire diameter is being reduced.

In view of this, it is necessary to provide an automatic-alignment load-detection apparatus and method used for a wire drawing machine, so that at the same time when a wire is being pulled, a drawing die can be replaced at a proper time, and meanwhile, the quality of the wire can also be determined in real time, so as to decide to accept or reject the wire, thereby improving a product yield.

### SUMMARY

A major object of the present invention is to provide an automatic-alignment load-detection method used for a wire drawing machine, so that at the same time when a wire is being pulled, a wear degree of a drawing die can be detected in real time, and the quality of the wire can be determined in real time.

To achieve the foregoing object, an automatic-alignment load-detection method used for a wire drawing machine of the present invention comprises the following steps:

An automatic-alignment load-detection apparatus used for a wire drawing machine is provided, and comprises: a drawing die, an adapter ring, a tapered spacer, and a force sensor. The adapter ring is sleeved over the drawing die. The tapered spacer is disposed on a side of the adapter ring, and is used to be aligned with and held against the adapter ring. The force sensor is disposed on a first side of the tapered spacer.

A pulling force is applied, to enable a wire to pass through the drawing die, the adapter ring, the tapered spacer, and the force sensor.

When the wire passes through the drawing die and rubs against the drawing die, the wire drives the drawing die and the adapter ring to displace toward the tapered spacer in an axial-direction parallel to the wire, so that an end surface of the adapter ring is automatically aligned with a tapered groove of the tapered spacer. When the wire passes through the drawing die, the wire applies a force on the drawing die to generate an axial-direction load, so that the axial-direction load is transferred to the force sensor through the adapter ring and the tapered spacer, so as to detect the axial-direction load.

Another object of the present invention is to provide an automatic-alignment load-detection apparatus used for a wire drawing machine, which is used to detect an axial-direction load generated as a wire rubs against a drawing die.

To achieve the foregoing object, an automatic-alignment load-detection apparatus used for a wire drawing machine of the present invention comprises: a drawing die, an adapter ring, a tapered spacer, and a force sensor.

The drawing die comprises: a first tapered hole, a second tapered hole, and an equal-diameter through hole. The first and second tapered holes both gradually reduce in size toward the inside of the drawing die. The equal-diameter through hole is provided between the first and second tapered holes, and is communicate with the first and second tapered holes.

The adapter ring is sleeved over the drawing die, and comprises a first penetrating hole, wherein the first penetrating hole is communicate with the second tapered hole.

The tapered spacer is disposed on a side of the adapter ring, and is used to be aligned with and held against the adapter ring, and the tapered spacer comprises a second penetrating hole, wherein the second penetrating hole is communicate with the first penetrating hole.

The force sensor is disposed on a first side of the tapered spacer, and the force sensor comprises a third penetrating hole, wherein the third penetrating hole is communicate with the second penetrating hole. When a wire rubs against the drawing die and generates an axial-direction load, the axial-direction load is transferred to the force sensor through the drawing die, the adapter ring, and the tapered spacer, so as to detect the axial-direction load.

A characteristic of the present invention lies in that, at the same time when a wire is being pulled, the wire can pass through the drawing die and rub against the drawing die, to enable the drawing die to apply a force on the adapter ring, the tapered spacer, and the force sensor, so as to further enable the force sensor to detect an axial-direction load, so that a wear degree of the drawing die can be detected in real time by using the axial-direction load, and the quality of the wire can be determined in real time.

To make the objectives, features, and advantages of the present invention more comprehensible, the present invention is described in detail below with reference to the accompanying drawings.

### BRIEF DESCRIPTION OF DRAWINGS

FIG. 1 is a schematic diagram of an automatic-alignment load-detection apparatus used for a wire drawing machine according to an embodiment of the present invention;

FIG. 2 is a flowchart of an automatic-alignment load-detection method used for a wire drawing machine according to an embodiment of the present invention;

FIG. 3 is a schematic diagram of a relationship between an axial-direction load and time according to an embodiment of the present invention, and the relationship is used to determine the wear of a drawing die;

FIG. 4 is a flowchart of an automatic-alignment load-detection method used for a wire drawing machine according to another embodiment of the present invention; and

FIG. 5 is a schematic diagram of a relationship between an axial-direction load and time according to an embodiment of the present invention, and the relationship is used to determine the quality of a wire.

### DETAILED DESCRIPTION OF DISCLOSED EMBODIMENTS

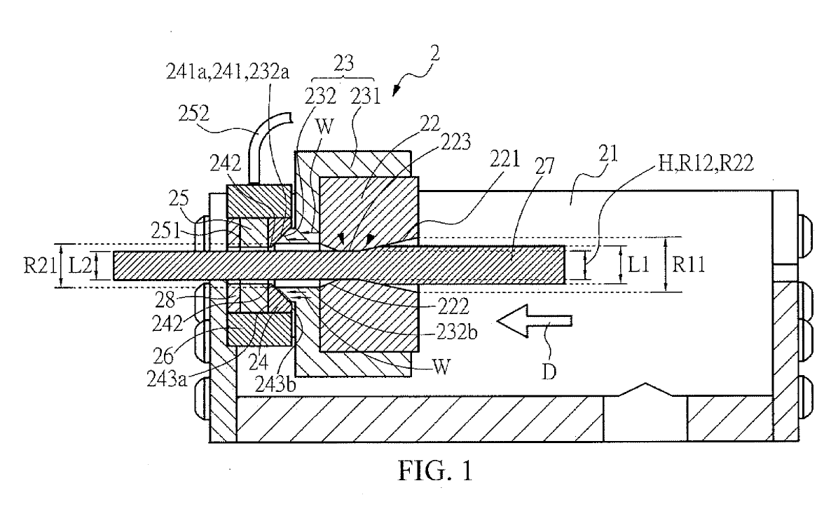

FIG. 1 is a schematic diagram of an automatic-alignment load-detection apparatus used for a wire drawing machine according to an embodiment of the present invention.

Referring to FIG. 1, the automatic-alignment load-detection apparatus 2 used for a wire drawing machine in this embodiment includes: a base 21, a drawing die 22, an adapter ring 23, a tapered spacer 24, a force sensor 25, a positioning ring 26, and a spacer ring 28.

The drawing die 22 is disposed inside the base 21, and the drawing die 22 includes: a first tapered hole 221, a second tapered hole 222, and an equal-diameter through hole 223. The first tapered hole 221 is provided at an end of the drawing die 22, the second tapered hole 222 is provided at the other end of the drawing die 22, and the first tapered hole 221 and the second tapered hole 222 both gradually reduce in size toward the inside of the drawing die 22. The equal-diameter through hole 223 is provided inside the drawing die 22, and two ends of the equal-diameter through hole 223 are separately communicate with the first tapered hole 221 and the second tapered hole 222. In this embodiment, a first maximum hole diameter R11 of the first tapered hole 221 is greater than a second maximum hole diameter R21 of the second tapered hole 222, and a first minimum hole diameter R12 of the first tapered hole 221 and a second minimum hole diameter R22 of the second tapered hole 222 are equal to a hole diameter H of the equal-diameter through hole 223.

The adapter ring 23 is sleeved over the drawing die 22. Specifically, the adapter ring 23 includes: a sleeve ring 231 and a tapered protrusion 232. The sleeve ring 231 is sleeved over the drawing die 22. The tapered protrusion 232 is disposed on a side of the sleeve ring 231, and the tapered protrusion 232 and the sleeve ring 231 may be integrally manufactured. The tapered protrusion 232 includes an end surface 232a and a first penetrating hole 232b. In this embodiment, the end surface 232a is an inclined surface, the first penetrating hole 232b is communicate with the second tapered hole 222, and a hole diameter of the first penetrating hole 232b is approximately equal to the second maximum hole diameter R21 of the second tapered hole 222. That is, the hole diameter of the first penetrating hole 232b is greater than the hole diameter H of the equal-diameter through hole 223.

The tapered spacer 24 is disposed on a side of the adapter ring 23, and the tapered spacer 24 includes: a tapered groove 241 and a second penetrating hole 242. The tapered groove 241 is disposed on a second side 243b of the tapered spacer 24, and a groove surface 241a of the tapered groove 241 can be held against the end surface 232a of the adapter ring 23. Specifically, the groove surface 241a of the tapered groove 241 is an inclined surface, and can be held against the end surface 232a of the tapered protrusion 232. The second penetrating hole 242 is communicate with the tapered groove 241 and the first penetrating hole 232b of the tapered protrusion 232 of the adapter ring 23. In this embodiment, a hole diameter of the second penetrating hole 242 is slightly less than the hole diameter of the first penetrating hole 232b, and the hole diameter of the second penetrating hole 242 is greater than the hole diameter H of the equal-diameter through hole 223.

The force sensor 25 is disposed on a first side 243a of the tapered spacer 24, and the force sensor 25 includes a third penetrating hole 251, wherein the third penetrating hole 251 is communicate with the second penetrating hole 242. In this embodiment, a hole diameter of the third penetrating hole 251 is approximately equal to the hole diameter of the second penetrating hole 242, and the hole diameter of the third penetrating hole 251 is greater than the hole diameter H of the equal-diameter through hole 223.

The positioning ring 26 is mounted at the base 21, and is used to radially mounting the tapered spacer 24 and the force sensor 25. In this embodiment, a signal line 252 of the force sensor 25 passes through the positioning ring 26, and the signal line 252 is used to be electrically connected to a monitoring end (not shown, for example, a monitoring room).

The spacer ring 28 is disposed on a side of the force sensor 25. By using a thickness of the spacer ring 28, axial positions of the force sensor 25 and the tapered spacer 24 can be decided, and thus a distance between the tapered protrusion 232 and the tapered spacer 242 is adjusted.

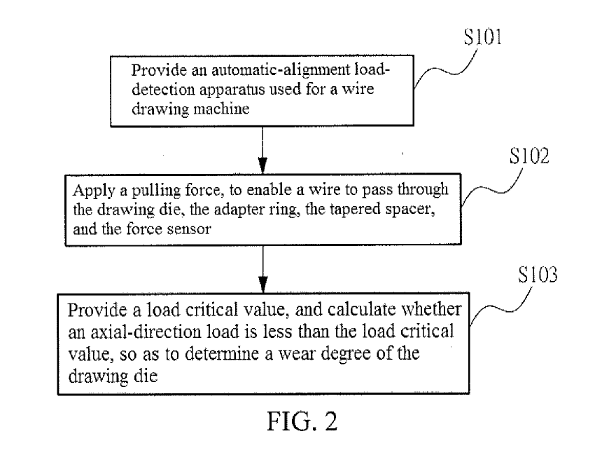

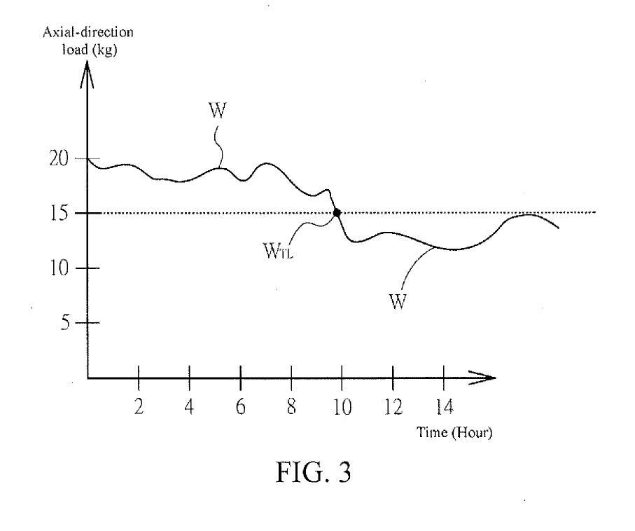

FIG. 2 is a flowchart of an automatic-alignment load-detection method used for a wire drawing machine according to an embodiment of the present invention. FIG. 3 is a schematic diagram of determining the wear of a drawing die according to an embodiment of the present invention.

Referring to FIG. 2 and FIG. 3, and further referring to FIG. 1 at the same time, the automatic-alignment load-detection method used for a wire drawing machine in this embodiment includes the following steps:

Step S101: Provide an automatic-alignment load-detection apparatus used for a wire drawing machine. The automatic-alignment load-detection apparatus 2 used for a wire drawing machine is described above, and is no longer further elaborated herein.

Step S102: Apply a pulling force, to enable a wire to pass through the drawing die, the adapter ring, the tapered spacer, and the force sensor. The automatic-alignment load-detection apparatus 2 in this embodiment is mainly used for a wire drawing machine and has a wire drawing use. Therefore, when a wire 27 passes through the drawing die 22 and rubs against the drawing die 22, the wire 27 drives the drawing die 22 and the adapter ring 23 to displace toward the tapered spacer 24 in an axial-direction D parallel to the wire 27, so that the end surface 232a of the adapter ring 23 is automatically aligned with the tapered groove 241 of the tapered spacer 24.

Specifically, in this embodiment, before the wire 27 passes through the drawing die 22, a wire diameter L1 of the wire 27 is greater than the hole diameter H of the equal-diameter through hole 223, and is less than the first maximum hole diameter R11 of the first tapered hole 221. Therefore, if the wire 27 passes through the first tapered hole 221 and the equal-diameter through hole 223, the wire 27 is pressed by and rubbed against the first tapered hole 221 and the equal-diameter through hole 223 to form the wire 27 having a relatively small wire diameter L2 (less than the wire diameter L1).

Next, at the same time when the wire 27 passes through the first tapered hole 221 and the equal-diameter through hole 223, the wire 27 applies a force on the drawing die 22 and drives the drawing die 22 and the adapter ring 23 to displace toward the tapered spacer 24 in the axial-direction D parallel to the wire 27, so that the end surface 232a of the tapered protrusion 232 is automatically aligned with the tapered groove of the tapered spacer, that is, the end surface 232a of the tapered protrusion 232 is held against the groove surface 241a of the tapered groove 241.

Step S103: Provide a load critical value, and calculate whether an axial-direction load is less than the load critical value, so as to determine a wear degree of the drawing die. Specifically, when the wire 27 passes through the drawing die 22, the wire applies a force on the drawing die and rubs against the drawing die 22 (that is, is rubbed against the first tapered hole 221 and the equal-diameter through hole 223) to generate an axial-direction load, so that the axial-direction load is transferred to the force sensor 25 through the drawing die 22, the sleeve ring 231 and the tapered protrusion 232 of the adapter ring 23, and the tapered spacer 24, to enable the force sensor 25 to detect the axial-direction load, and the axial-direction load is transferred to the monitoring end by using the signal line 252, so that the monitoring end can calculate whether the axial-direction load is less than the load critical value (a preset value), so as to determine a wear degree of the drawing die 22 (that is, a degree in which the hole diameter of the equal-diameter through hole 223 is increased). The load critical value is obtained according to an actual axial-direction load when the wire 27 passes through the drawing die 22 in advance plus an empirical value estimated according to the wire diameter of the wire 27. When the wire diameter of the wire 27 is greater, the load critical value is increased.

For example, as shown in FIG. 3, when the wear of the drawing die 22 is greater, the hole diameter of the equal-diameter through hole 223 becomes larger, and in the same time, the axial-direction load becomes smaller. The axial-direction load W obtained as the wire 27 passes through the drawing die 22 at an interval of time (every hour) is recorded. Once the axial-direction load W is less than the load critical value W_{TL} (for example, 15 kg), it represents that the drawing die 22 exceeds a wear standard, and a user is reminded that the drawing die 22 must be replaced. For example, after 10 hours, the axial-direction load W starts to be less than the load critical value W_{TL} (15 kg), it represents that the drawing die 22 exceeds the wear standard and must be replaced.

In another embodiment, in order to determine whether the drawing die has worn, a look-up table (not shown) of a correspondence between an axial-direction load and a wear degree of a drawing die may also be established, so that a user can find out, according to an axial-direction load sensed by the force sensor and by using the look-up table, a wear degree of a drawing die corresponding to the axial-direction load (for example, when the axial-direction load W is 10 kg, the wear degree of the drawing die has low-degree wear; when the axial-direction load W is 15 kg, the wear degree of the drawing die has medium-degree wear; and when the axial-direction load W is 20 kg, the wear degree of the drawing die has high-degree wear), so as to understand a current wear condition of the drawing die.

As can be seen from above, by means of the automatic-alignment load-detection apparatus used for a wire drawing machine, in a process of pulling the wire, the wire may be used to drive the drawing die to apply a force in an axial-direction and generate an axial-direction load, so that the axial-direction load is transferred to the force sensor through the sleeve ring and a tapered protrusion of the adapter ring and the tapered spacer, so as to further enable the force sensor to detect a value of the axial-direction load. Therefore, for the automatic-alignment load-detection method used for a wire drawing machine in this embodiment, the automatic-alignment load-detection apparatus used for a wire drawing machine can be used to detect a wear degree of the drawing die in real time at the same time when the wire is being pulled, so as to replace the drawing die at a proper time, which avoids that in a conventional manner a drawing die must be disassembled to determine whether the drawing die is worn, and saves effort, labor, and time.

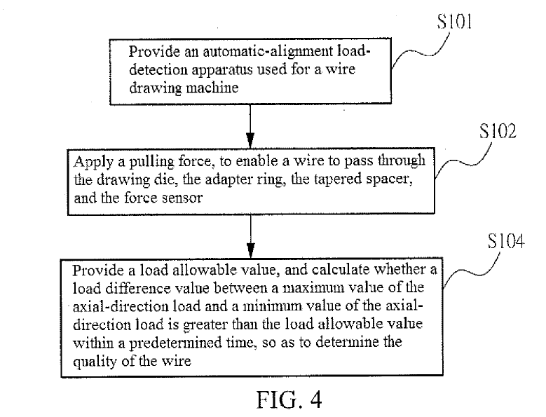

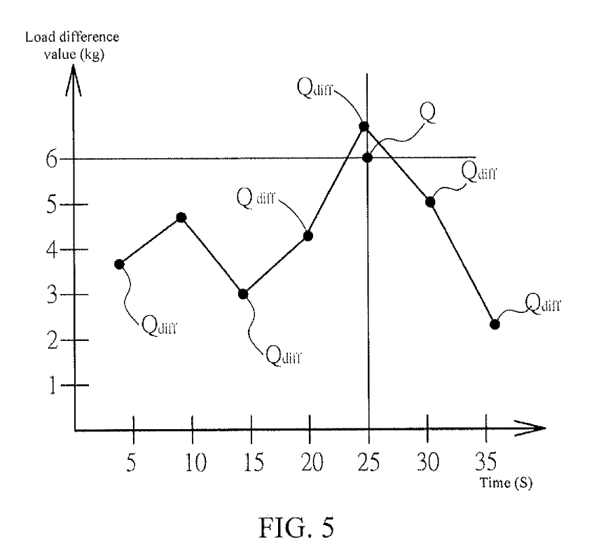

FIG. 4 is a flowchart of an automatic-alignment load-detection method used for a wire drawing machine according to another embodiment of the present invention. FIG. 5 is a schematic diagram of determining the quality of a wire according to an embodiment of the present invention.

Referring to FIG. 4 and FIG. 5, and further referring to FIG. 1 in combination, the automatic-alignment load-detection method used for a wire drawing machine in this embodiment is basically the same as the previous embodiment, and a major difference lies in that, after Step S101 (provide an automatic-alignment load-detection apparatus used for a wire drawing machine) and Step S102 (apply a pulling force, to enable a wire to pass through the drawing die, the adapter ring, the tapered spacer, and the force sensor), Step S104 can be further provided: Provide a load allowable value, and calculate whether a load difference value between a maximum value of the axial-direction load and a minimum value of the axial-direction load is greater than the load allowable value within a predetermined time, so as to determine the quality of the wire.

For example, as shown in FIG. 5, a user can preset the load allowable value Q (for example, 6 kg), and calculate the load difference value Q_{diff} by using 5 seconds as a predetermined time (unit: second S). It may be obtained that at a 25^{th} second, the calculated load difference value Q_{diff} exceeds the load allowable value Q, representing that the wire 27 is a poor-quality wire. Thus, the user can determine the quality of the wire 27 and decide to accept or reject the wire, thereby improving a product yield.

Therefore, for the automatic-alignment load-detection method used for a wire drawing machine in this embodiment, the automatic-alignment load-detection apparatus used for a wire drawing machine can be used to detect quality of a wire in real time at the same time when the wire is being pulled, so as to decide to accept or reject the wire, thereby improving a product yield.

The above merely records implementation manners or embodiments of the technical means used to resolve problems presented in the present invention, and the implementation manners or embodiments are not used to limit the scope of patent implementation of the present invention. That is, any equivalent variations and modifications that conform to the meaning of the patent claims of the present invention or that are made according to the patent scope of the present invention shall fall within the patent scope of the present invention.

What is claimed is:

1. An automatic-alignment load-detection method used for a wire drawing machine, comprising the following steps of:
providing an automatic-alignment load-detection apparatus used for a wire drawing machine, the automatic-alignment load-detection apparatus comprising:
a drawing die;
an adapter ring, sleeved over the drawing die;
a tapered spacer, disposed on a side of the adapter ring, and used to be aligned with and held against the adapter ring; and
a force sensor, disposed on a first side of the tapered spacer; and
applying a pulling force, to enable a wire to pass through the drawing die, the adapter ring, the tapered spacer, and the force sensor;
wherein:
when the wire passes through the drawing die and rubs against the drawing die, the wire drives the drawing die and the adapter ring to displace toward the tapered spacer in an axial-direction parallel to the wire, so that an end surface of the adapter ring is automatically aligned with a tapered groove of the tapered spacer; and
when the wire passes through the drawing die, the wire applies a force on the drawing die to generate an axial-direction load, so that the axial-direction load is transferred to the force sensor through the adapter ring and the tapered spacer, so as to detect the axial-direction load.

2. The automatic-alignment load-detection method used for a wire drawing machine according to claim 1, further comprising step of: providing a load critical value, and calculating whether the axial-direction load is less than the load critical value, so as to determine a wear degree of the drawing die.

3. The automatic-alignment load-detection method used for a wire drawing machine according to claim 1, further comprising step of: providing a load allowable value, and calculating whether a load difference value between a maximum value of the axial-direction load and a minimum value of the axial-direction load is greater than the load allowable value within a predetermined time, so as to determine quality of the wire.

4. An automatic-alignment load-detection apparatus used for a wire drawing machine, comprising:
a drawing die, comprising:
a first tapered hole and a second tapered hole, both gradually reducing in size toward the inside of the drawing die; and
an equal-diameter through hole, disposed between the first and second tapered holes, and communicate with the first and second tapered holes;
an adapter ring, sleeved over the drawing die, and comprising a first penetrating hole, wherein the first penetrating hole is communicate with the second tapered hole;
a tapered spacer, disposed on a side of the adapter ring, used to be aligned with and held against the adapter ring, and comprising a second penetrating hole, wherein the second penetrating hole is communicate with the first penetrating hole; and
a force sensor, disposed on a first side of the tapered spacer, and comprising a third penetrating hole, wherein the third penetrating hole is communicate with the second penetrating hole, wherein when a wire rubs against the drawing die and generates an axial-direction load, the axial-direction load is transferred to the force sensor through the drawing die, the adapter ring and the tapered spacer, so as to detect the axial-direction load.

5. The automatic-alignment load-detection apparatus used for a wire drawing machine according to claim 4, wherein a first maximum hole diameter of the first tapered hole is greater than a second maximum hole diameter of the second tapered hole.

6. The automatic-alignment load-detection apparatus used for a wire drawing machine according to claim 4, wherein the tapered spacer comprises:
a tapered groove, disposed on a second side of the tapered spacer, wherein a groove surface of the tapered groove is held against an end surface of the adapter ring; and
the second penetrating hole, communicate with the tapered groove and the first penetrating hole.

7. The automatic-alignment load-detection apparatus used for a wire drawing machine according to claim 6, wherein the adapter ring comprises:
a sleeve ring, sleeved over the drawing die; and
a tapered protrusion, disposed on a side of the sleeve ring, and the tapered protrusion comprising the end surface and the first penetrating hole.

8. The automatic-alignment load-detection apparatus used for a wire drawing machine according to claim 4, wherein hole diameters of the first penetrating hole, the second penetrating hole and the third penetrating hole are greater than a hole diameter of the equal-diameter through hole.

9. The automatic-alignment load-detection apparatus used for a wire drawing machine according to claim 4, wherein a first minimum hole diameter of the first tapered hole and a second minimum hole diameter of the second tapered hole are equal to a hole diameter of the equal-diameter through hole.

10. The automatic-alignment load-detection apparatus used for a wire drawing machine according to claim 4, further comprising:
a base;
a positioning ring, mounted at the base, and used to radially mounting the tapered spacer and the force sensor; and
a spacer ring, disposed on a side of the force sensor, and used to decide axial positions of the force sensor and the tapered spacer.
